(19) United States
(12) Patent Application Publication
(10) Pub. No.: US 2003/0214222 A1
(43) Pub. Date: Nov. 20, 2003

(54) Cathode ray tube

(76) Inventors: Hidetsugu Matsukiyo, Mobara (JP); Naomitsu Watanabe, Mobara (JP); Masaki Nishikawa, Mobara (JP); Yoshihiro Koseki, Chiba (JP); Koji Sakakibara, Mauldin, SC (US)

Correspondence Address: James R. Klaiber, Esq., Milbank, Tweed, Hadley & McCloy LLP, 1 Chase Manhattan Plaza, New York, NY, 10005-1413, US

(21) Appl. No.: 10/271,217

(22) Filed: Oct. 15, 2002

(30) Foreign Application Priority Data
Oct. 29, 2001 (JP) 2001-330297

(51) Int. Cl. H01J 31/00

(52) U.S. Cl. 313/479

(57) ABSTRACT

The present invention provides a cathode ray tube which can suppress a coloring phenomenon of a panel glass which is attributed to the irradiation of electron beams. At an electron beam irradiation side of a panel glass PNL of the cathode ray tube PRT, a transparent thin oxide layer TF of an element whose reduction by the irradiation of electron beams is difficult is formed. With the provision of the transparent thin oxide layer TF, the present invention suppresses the coloring phenomenon of the panel glass attributed to the irradiation of electron beams.

### BACKGROUND OF THE INVENTION

1. Field of the Invention

The present invention relates to a cathode ray tube, and more particularly to a cathode ray tube which is capable of suppressing a coloring phenomenon of a panel glass which is attributed to the irradiation of electron beams.

2. Description of the Related Art

Although various types of cathode ray tubes have been known as display devices, with respect to a color image reproducing device or a so-called color projector in particular, a tri-color projection type of cathode ray tube has been popularly used.

FIG. 7 is a schematic view for explaining an example of arrangement of an optical system of a color projector. In the color projector having such an optical system, that is, a three tube type of color projector, images of respective colors which are generated on respective color panel glasses PNL of a red-color projection type of cathode ray tube rPRT, a green-color projection type of cathode ray tube gPRT and a blue-color projection type of cathode ray tube bPRT are projected onto a projection screen SCR by projecting lenses LNS and the images in three colors are combined on the projection screen SCR to reproduce color images.

In each projection type of cathode ray tube having such a constitution, a phosphor layer is formed on an inner surface of the panel glass PNL, electron beams having high density which are irradiated from an electron gun are deflected by vertical and horizontal deflecting magnetic fields generated by a deflection yoke not shown in the drawing, and the phosphor layer is subjected to a two-dimensional scanning. Then, lights of phosphors emitted by scanning are projected onto the projection screen SCR using respective projection lenses LNS.

The electron beams which are irradiated from the electron gun excite the phosphor layer and emit light of a given color. The emitted light of phosphor is irradiated from an outer surface of the panel glass PNL and reaches the above-mentioned screen SCR. However, the irradiation of the electron beams of high density to the phosphor layer for a long time makes a portion of electron beams which reach the panel glass PNL after passing the phosphor layer generate a coloring phenomenon on the panel glass PNL. Usually, such coloring is brown and hence, the phenomenon is referred to as “browning”. Such coloring on the glass panel PNL absorbs light in a range from green to blue and hence, it has been one of causes which prevent the prolongation of life of the green-color and blue-color projection type of cathode ray tubes.

FIG. 8 is a comparison explanatory view of the normalized luminance and the transmissivity of a cathode ray tube which directly forms a phosphor layer on an inner surface of a panel glass. In the drawing, the wavelength (nm) is taken on the axis of abscissas, the normalized luminance which indicates the relative luminance when the initial luminance is normarized to 1 is taken on the right-side axis of ordinates, and the light transmissivity is taken on the left-side axis of ordinates.

In FIG. 8, the reference symbol B indicates an emission spectrum of a blue-color phosphor, the reference symbol G indicates an emission spectrum of a green-color phosphor, and the reference symbol R indicates an emission spectrum of a red-color phosphor. Further, a curve F indicates a diffusion transmissivity of the panel glass before the irradiation of electron beams, while a curve D indicates the diffusion transmissivity of the panel glass on which the browning is generated due to the irradiation of electron beams for a long period. As can be readily understood from the comparison of the curves F and D, the transmissivity of the panel glass on which the browning is generated is sharply decreased in a short wavelength range.

Further, the scattering of light in the inside of the phosphor layer loweres the resolution. To achieve the further enhancement of the resolution of reproduced images, the suppression of the scattered light in the phosphor layer has been studied. As a major countermeasure to suppress the scattered light in the phosphor layer, there exists a method which makes a coated film thinner using small phosphor particles. Recently, with respect to this type of cathode ray tube, there has been a tendency that the phosphor layer is formed using such a thin layer formed of small phosphor particles.

However, when the thickness of the phosphor layer is decreased, the electron beams emitted from the electron gun easily reach the panel glass and hence, the occurrence of the above-mentioned browning becomes apparent. On the other hand, when the panel is formed of quartz in place of glass, the occurrence of the browning is not observed noticeably.

As techniques which cope with the browning, there have been known techniques which are disclosed in Japanese Laid-open Patent Publication 228153/2000, Japanese Laid-open Patent Publication 206466/1995 and the like. In Japanese Laid-open Patent Publication 228153/2000, quartz (SiO₂) and titanium oxide (TiO₂) are filled among phosphor particles coated on an inner surface of a panel glass so as to decrease an amount of electron beams which reach the panel glass. To be more specific, SiO₂ having an average particle size of 0.05 μm is mixed into the phosphor (for example, green-color phosphor Y₂SiO₂ having an average particle size of 7 μm) at a weight ratio of 100:7 and the mixed material is applied at a film thickness of 25 to 35 μm to form a phosphor layer.

Japanese Laid-open Patent Publication 206466/1995 proposes a panel glass composition having a high X-ray absorption coefficient. That is, based on an understanding that a cause of the occurrence of browning lies in the lead oxide (PbO) present in the glass is reduced by the irradiation of electron beams, the use of the panel glass in which lead oxide is not added is proposed. Here, there has been also known a method in which X-ray browning which is caused by coloring of X rays can be decreased by adding cerium (Ce) ions to a panel glass.

However, when the fine particles are filled among the phosphor particles, the electron beams scatter due to the fine particles and hence, it is difficult to suppress the reaching of the electron beams to the panel glass. On the other hand, when the light scattering in the inside of the phosphor layer is decreased by decreasing the film thickness of the phosphor layer to increase the resolution, the rate that the electron beams reach the panel glass is increased. Further, when the fine particles which do not contribute to the emission of light are filled among the phosphor particles, the utilization efficiency of the electron beams in the phosphor layer is lowered.

Further, oxides of sodium (Na) and potassium (K) which constitute alkaline metals are contained in the panel glass and it is anticipated that the oxides are reduced to sodium and potassium by the irradiation of the electron beams. Accordingly, it is also anticipated that even when only the countermeasure that lead oxide is not added is taken, the browning is generated due to the above-mentioned reduction of the oxide.

When cerium is added into the panel glass, along with the increase of concentration of addition, the whole panel glass is colored in yellow. Accordingly, the panel glass absorbs an emission spectrum from the phosphor layer and a light emission quantity of a cathode ray tube is decreased and hence, the concentration of addition of cerium cannot be increased largely. The occurrence of such browning is not limited to the above-mentioned projection type of cathode ray tube and the browning occurs in the same manner with respect to a display monitor tube, a television receiver, other cathode ray tube, or a cathode ray tube having no phosphor on an inner surface of a panel glass or a cathode ray tube having a layer other than the phosphor layer.

### SUMMARY OF INVENTION

The basic constitution of the present invention lies in that a transparent thin oxide layer of an element whose reduction by the irradiation of electron beams is difficult is formed at an electron beam irradiation side of a panel glass of a cathode ray tube. To explain more specific constitutions of the present invention, they are as follows.

(1) A transparent thin oxide layer of an element whose reduction by the irradiation of electron beams is difficult at an electron beam irradiation side of a panel glass of a cathode ray tube is provided, and a phosphor layer is formed on the transparent thin oxide layer.

(2) In the constitution (1), the transparent oxide is any one of quartz, yttrium oxide, zirconium oxide or a combination of two or more elements selected from such elements.

(3) In the constitution (1) or (2), assuming the density of the transparent oxide as ρ(g/cm²), the acceleration voltage of the electron beams as E (V), and the invasion depth of the electron beams to the transparent thin oxide layer as d (cm), the thickness (cm) of the transparent oxide is determined by a following equation.

d=E²/(β×ρ)

wherein, β is a constant (6.2×10¹¹(V²·g⁻¹·cm²))

When the electron beams which pass the phosphor layer invade the above-mentioned transparent thin oxide layer and passes the inside of the transparent thin oxide layer, the energy is consumed. Accordingly, the reaching of the electron beams to the panel glass is interrupted or restricted and hence, even when the element which is reduced by the irradiation of electron beams is mixed into the panel glass, the occurrence of the above-mentioned browning can be suppressed or prevented. The present invention can provide the cathode ray tube which is capable of suppressing a coloring phenomenon of the panel glass attributed to the irradiation of electron beams.

It is needless to say that the present invention is not limited to the above-mentioned constitutions and constitutions of embodiments which will be described later and various modifications can be made without departing from the technical concept of the present invention.

### BRIEF DESCRIPTION OF THE DRAWINGS

FIG. 1A is a side view with a part broken away showing an essential part of a projection type of cathode ray tube according to the present invention and FIG. 1B is a cross-sectional view of an essential part in the vicinity of a panel glass shown in FIG. 1A.

FIG. 2 is an explanatory view which is prepared by copying an scanning type of electron microscope photograph of a portion shown in FIG. 1B.

FIG. 3 is an explanatory view of another method for forming a quartz thin film on the panel glass.

FIG. 4 is an explanatory view showing a result of measurement of luminance of the panel glass which constitutes the cathode ray tube of the present invention.

FIG. 5 is a front view for explaining one example of an image display device using the cathode ray tube of the present invention.

FIG. 6 is an explanatory view of an example of an inner arrangement of the image display device shown in FIG. 5.

FIG. 7 is a schematic view for explaining an example of an arrangement of an optical system of a color projector.

FIG. 8 is a comparison explanatory view of the normalized luminance and the diffusion transmissivity of the cathode ray tube which directly forms a phosphor layer on an inner surface of a panel glass.

### DESCRIPTION OF THE PREFERRED EMBODIMENTS

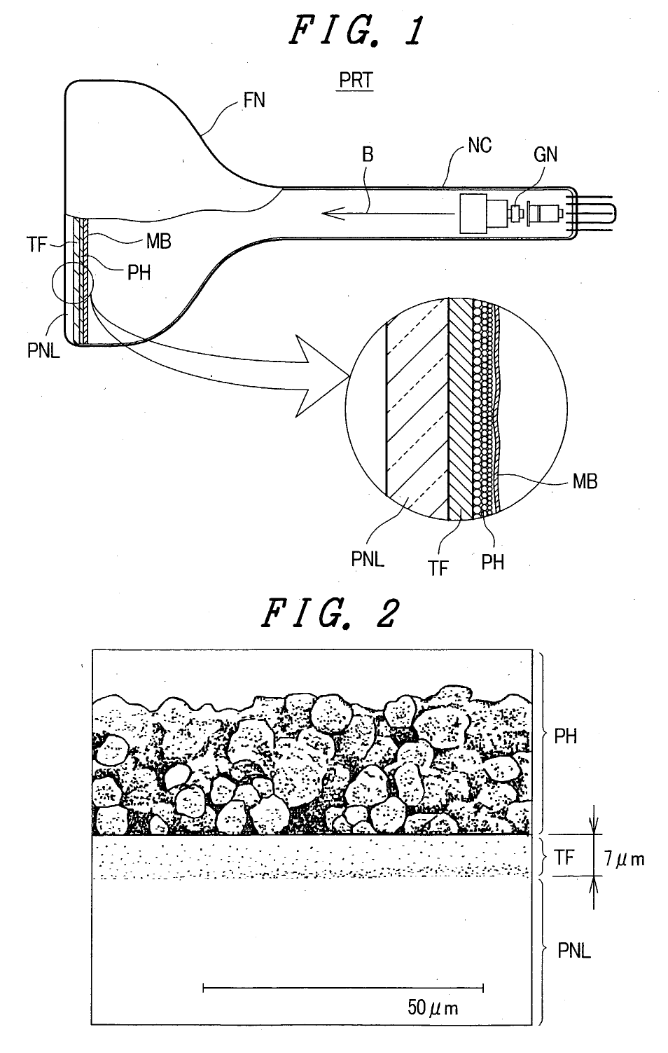

Preferred embodiments of the present invention are explained in detail hereinafter in conjunction with attached drawings which illustrate the embodiments. In the drawings, FIG. 1A is an explanatory view showing an example of the structure of a projection type of cathode ray tube which constitutes a typical example of the cathode ray tube according to the present invention and is also a side view with an essential part broken away. FIG. 1B is a cross-sectional view of an essential part for explaining the vicinity of the panel glass in FIG. 1A in detail.

In FIG. 1A, reference symbol PRT indicates a whole projection type of cathode ray tube, reference symbol PNL indicates a panel glass, reference symbol FN indicates a funnel, reference symbol NC indicates a neck, reference symbol GN indicates an electron gun, and reference symbol B indicates electron beams. Further, reference symbol TF indicates a quartz (SiO₂) layer which is formed on an inner surface, that is, an electron-beam-B-irradiation side of the panel glass PNL, reference symbol PH indicates a phosphor layer, and MB indicates a metal back layer (aluminum layer).

In this projection type of cathode ray tube PRT, the electron beams B which are emitted from the single electron gun GN housed in the inside of the neck NC are deflected in two directions consisting of the horizontal direction and the vertical direction by a deflection yoke (not shown in the drawing) which is exteriorly mounted on a boundary region between the neck NC and the funnel FN so as to scan the phosphor layer PH which is formed on the panel glass PNL two-dimensionally and an image light of color corresponding to the phosphor PH is irradiated from the panel glass PNL.

FIG. 2 is an explanatory view which is a copy of a scanning type of electron microscope photograph of a portion shown in FIG. 1B. In the drawings, reference symbols correspond to the reference symbols used in FIG. 1A and FIG. 1B to indicate identical portions. On the inner surface of the panel glass PNL, the quartz (SiO₂) layer TF having a thickness of 7 μm is formed. Further, on the quartz (SiO₂) layer TF, (that is, an electron-beam-irradiation side), the phosphor layer PH is applied. Further, it is possible to use yttrium oxide (Y₂O₃) in place of quartz (SiO₂). As a method for forming the above-mentioned thin film made of quartz (SiO₂) or yttrium oxide (Y₂O₃), a thin film growth method using a sputtering method or an electron beam deposition method is named.

Here, one example of the method which forms a film made of quartz (SiO₂) using a sputtering method is explained. Using a high frequency sputtering device, quartz (SiO₂) is formed on the inner surface of the commercially available panel glass at an output of approximately 1 kw for four hours. As a result, the quartz (SiO₂) layer TF having a film thickness of 7 μm is formed as mentioned above. FIG. 2 shows a state in which the phosphor PH is applied to the quartz (SiO₂) layer TF. Here, the transmissivity of the panel glass PNL is 99.0% at a wavelength of 550 nm. This value is substantially equal to the value of the transmissivity of the panel glass without the quartz (SiO₂) layer TF. Further, coloring attributed to the growth of the quartz (SiO₂) layer TF is not observed.

Further, another method for forming the quartz (SiO₂) layer TF as the transparent thin oxide layer of an element whose reduction is difficult by the irradiation of electron beams on the inner surface of the panel glass PNL is performed as follows.

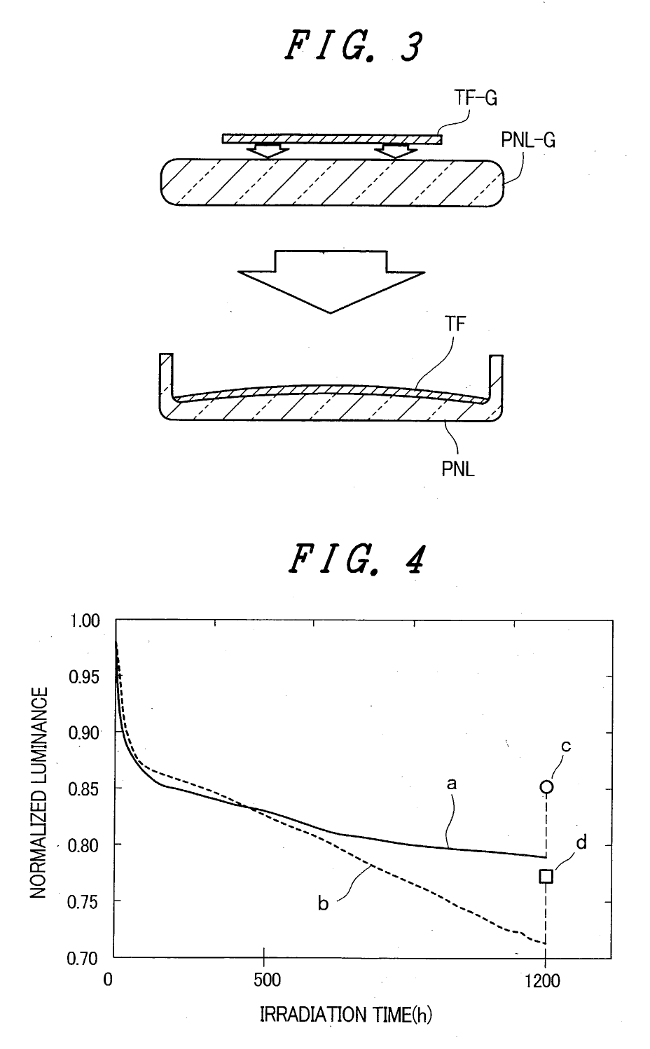

FIG. 3 is an explanatory view of another method for forming the quartz thin film on the panel glass. In this method, a panel glass material PNL-G for molding the panel glass is melted at a high temperature and the panel glass material PNL-G is molded by a press in a state that a thin sheet TF-G made of quartz (SiO₂) is overlapped to a phosphor-screen-forming side of the panel glass PNL. As a result, on an inner surface of a molded panel glass PNL, a thin film TF made of quartz (SiO₂) which is a transparent thin oxide film of an element whose reduction by the irradiation of electron beams is difficult is formed. By using a thin sheet made of yttrium oxide (Y₂O₃) in place of the thin plate made of quartz (SiO₂), it is possible to obtain the panel glass on which the transparent thin oxide layer TF of an element whose reduction by the irradiation of electron beams is difficult is formed by similar press molding.

In applying the thin film growth method using the sputtering method or the electron beam deposition method or the press forming to the panel glass material PNL-G, it may be possible that the inner surface of the panel glass material PNL-G is made coarse and, thereafter, the thin layer made of quartz (SiO₂) is formed on the inner surface of the panel glass material PNL-G.

The projection type of cathode ray tube is produced by using the panel glass having the transparent thin oxide layer which is formed in the above-mentioned manner. The applied phosphor is a green-color phosphor (Y₂SiO₅: Tb) having an average particle size of approximately 6 μm. Using this green-color phosphor, the coating is performed by a flocculation process in which water glass (K₂O.nSiO₂, n; 2.8) is used as a binder and barium acetate (Ba(CH₃COOH)₂) is selected as an electrolyte. Here, the weight of film is approximately 3 mg/cm² and a thickness of the phosphor layer per se is approximately 17 μm. Then, a filming made of organic material is applied and, thereafter, aluminum is deposited. Then, the heat treatment is performed at a temperature of approximately 450 degree centigrade to remove the filming by baking, thus forming a metal back made of aluminum.

FIG. 4 is an explanatory view showing a result of the measurement of luminance of the panel glass which constitutes the cathode ray tube of the present invention. An object to be measured is a projection type of cathode ray tube which is formed by the above-mentioned method. FIG. 4 shows the measured value of the sequential change of luminance when the phosphor is excited at the acceleration voltage of 30 kV, the irradiation current of 0.36 mA and the irradiation area of 40 mm×30 mm by heating the panel glass at a temperature of approximately 120 degree centigrade. A used measuring instrument is a color chrominance meter “CS-100” made of Minolta and the luminance over the panel glass is measured. In FIG. 4, the axis of abscissas indicates the irradiation time (h) of electron beams and the axis of ordinates indicates the relative ratio of luminance change when the initial luminance is normalized to 1.00 (normalized luminance).

In FIG. 4, a curve “a” indicates the luminance change of the panel glass of the projection type of cathode ray tube according to the embodiment of the present invention and a curve “b” indicates the luminance change of the panel glass which is measured using a projection type of cathode ray tube which forms no quartz (SiO₂) on an inner surface of a commercially available panel glass used in the same manner as the embodiment for comparison.

Under the above-mentioned excitation conditions, the electron beams are continuously irradiated for 12 hours and, thereafter, the irradiation is interrupted for 10 minutes, and the luminance is again measured. The ratio with respect to the initial value, that is, the luminance holding ratio is indicated by points “c” and “d” in FIG. 4. The point “c” indicates the measured result of the luminance holding ratio of the projection type of cathode ray tube which forms the quartz (SiO₂) on the inner surface of the panel glass and the point “d” indicates the measured result of the luminance holding ratio of the projection type of cathode ray tube which forms no quartz (SiO₂) on the inner surface of the panel glass. As can be clearly understood from these points “c” and “d”, the luminance holding ratio is largely improved from 0.77 to 0.88 by forming the quartz (SiO₂) on the inner surface of the panel glass. Here, it is considered that a phenomenon that the normalized luminance is increased due to the interruption for 10 minutes after the irradiation for 12 hours is attributed to so-called thermal quenching which decreases the luminance due to the temperature elevation caused by the irradiation.

After performing a series of the above-mentioned operations, the metal back and the phosphor layer are removed and the light transmissivity of a portion which is subjected to the above-mentioned irradiation of electrons at a wavelength of 550 nm is measured. The light transmissivity of the projection type of cathode ray tube which forms the quartz (SiO₂) on the inner surface of the commercially available panel glass is 95.3%, while the light transmissivity of the projection type of cathode ray tube which forms no quartz (SiO₂) on the inner surface of the commercially available panel glass is 87.9%. From this result of measurement, it is proved that by forming the quartz (SiO₂) on the inner surface of the panel glass, the browning caused by the irradiation of electron beams is largely decreased and hence, the formation of the quartz (SiO₂) on the inner surface of the panel glass has a large advantageous effect in the suppression of the lowering of luminance (deterioration of transmissivity).

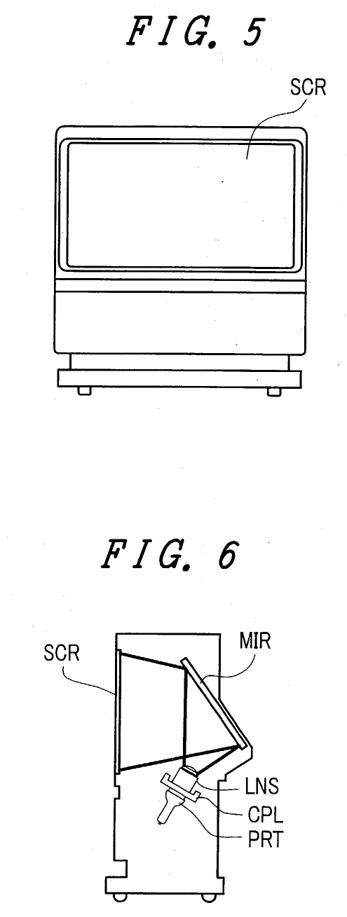

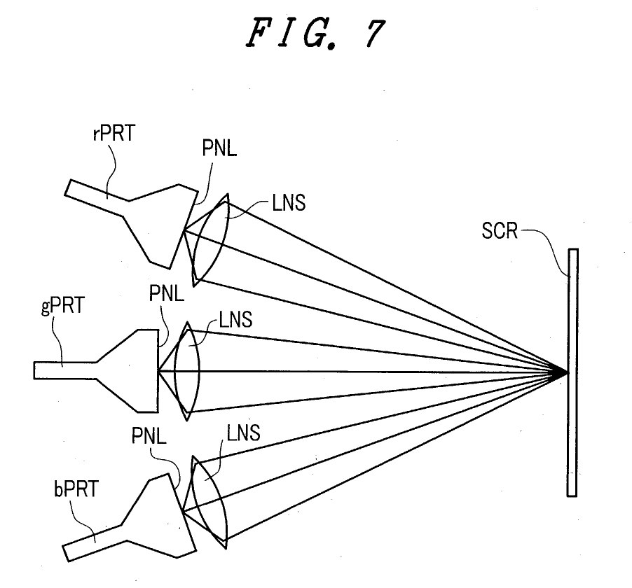

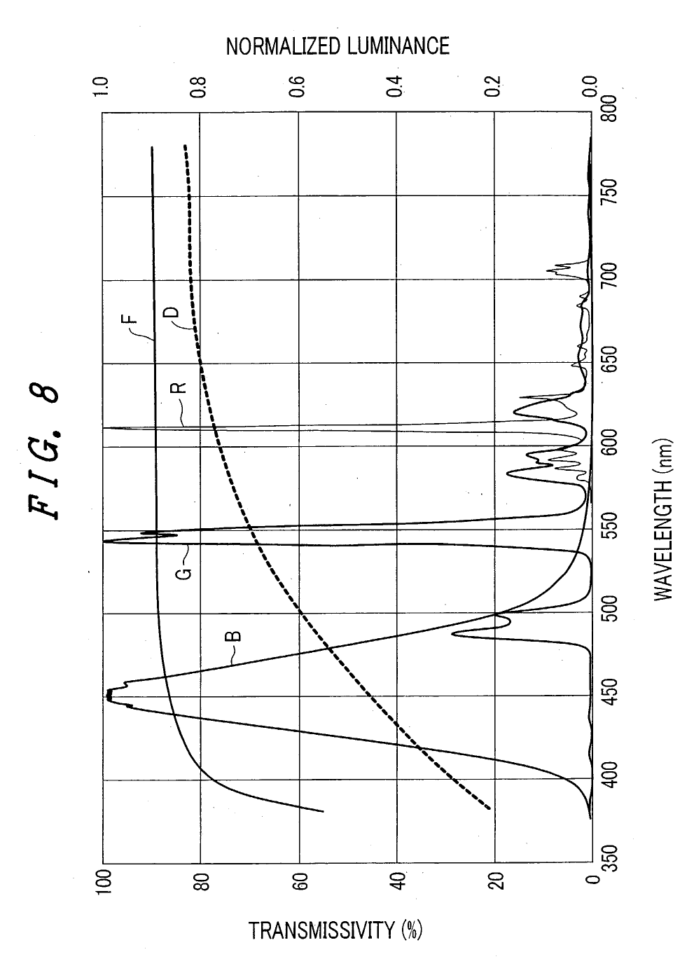

FIG. 5 is a front view for explaining one example of an image display device using the cathode ray tube of the present invention and FIG. 6 is an explanatory view showing an example of the arrangement of the inside of the image display device shown in FIG. 5. FIG. 5 and FIG. 6 show a so-called projection type of television receiver set, wherein three projection type of cathode ray tubes PRT corresponding to three primary colors (red, green, blue) which have been explained in conjunction with FIG. 7, projection lenses LMZ and a reflection mirror MIR are housed. Here, reference numeral CPL indicates couplings which are served for mounting the projection lenses LMZ to the projection type of cathode ray tubes PRT.

Respective primary color images formed on the phosphor layers provided to the panel glasses of three projection type of cathode ray tubes PRT are projected onto the screen SCR through the projection lenses LNS and the reflection mirror MIR. The respective projected primary color images are synthesized on the screen SCR at the time of the above-mentioned projecting so as to reproduce the color image. Here, the image display device shown in FIG. 5 and FIG. 6 merely constitutes one example and there exists an image display device which provides portions of the projection type of cathode ray tubes PRT as devices separate from the screen SCR.

Although the present invention is applied to the panel glass of the projection type of cathode ray tube in the above-mentioned embodiments, the present invention is not limited to such a projection type of cathode ray tube. That is, the present invention is applicable to an ordinary direct-viewing type of cathode ray tube and other various types of cathode ray tubes in the same manner.

As has been explained heretofore, according to the present invention, the coloring phenomenon of the panel glass attributed to the irradiation of electron beams can be suppressed and it is possible to provide the cathode ray tube which exhibits the sufficient luminance even after the irradiation of the electron beams for a long period.

What is claimed is:

1. A cathode ray tube characterized by forming a transparent thin oxide layer of material resistant to reduction by the irradiation of electron beams at an electron beam irradiation side of a panel glass.

2. A cathode ray tube according to claim 1, wherein a phosphor layer is formed on the transparent thin oxide layer.

3. A cathode ray tube according to claim 1 or 2, wherein the transparent oxide is any one of quartz, yttrium oxide, or zirconium oxide materials or a combination of two or more materials selected from said materials.

4. A cathode ray tube according to claim 1 or 2, wherein assuming the density of the transparent oxide as ρ(g/cm²), the acceleration voltage of the electron beams as E (V), and the invasion depth of the electron beams to the transparent thin oxide layer as d (cm), the thickness (cm) of the transparent oxide is determined by the following equation
d=E²/(β×ρ)
where β is a constant (6.2×10¹¹(V²·g⁻¹·cm²)).

5. A cathode ray tube according to claim 3, wherein assuming the density of the transparent oxide as ρ(g/cm²), the acceleration voltage of the electron beams as E (V), and the invasion depth of the electron beams to the transparent thin oxide layer as d (cm), the thickness (cm) of the transparent oxide is determined by the following equation
d=E²/(β×ρ)
where β is a constant (6.2×10¹¹(V²·g⁻¹·cm²)).
